(19) United States
(12) Patent Application Publication
(10) Pub. No.: US 2025/0132424 A1
(43) Pub. Date: Apr. 24, 2025

(54) LAMINATE BATTERY

(71) Applicant: TOYOTA JIDOSHA KABUSHIKI KAISHA, Toyota-shi (JP)

(72) Inventor: Kunimitsu YAMAMOTO, Kasugai-shi (JP)

(73) Assignee: TOYOTA JIDOSHA KABUSHIKI KAISHA, Toyota-shi (JP)

(21) Appl. No.: 18/813,297

(22) Filed: Aug. 23, 2024

(30) Foreign Application Priority Data
Oct. 23, 2023 (JP) 2023-181737

(51) Int. Cl. H01M 50/105; H01M 10/0562; H01M 50/571

(52) U.S. Cl. CPC H01M 50/105; H01M 10/0562; H01M 50/571

(57) ABSTRACT

The present disclosure provides a laminate battery having a reduced risk of the positive electrode current collector terminal corroding completely before the battery is fully discharged, and with which contact between salt water and charged electrode laminate can be suppressed. The laminate battery 1 of the present disclosure comprises an electrode laminate 10, a negative electrode current collector terminal 20, a positive electrode current collector terminal 30, and a laminate film 40. The positive electrode current collector terminal is formed of a metal which can be electrolytically corroded by a discharge potential of the electrode laminate, and (i) a volume of the positive electrode current collector terminal is greater than a volume which can be electrolytically corroded by a capacitance of the electrode laminate, and/or (ii) the positive electrode current collector terminal has a structure in which a cross-sectional area increases toward an end.

### FIELD

The present disclosure relates to a laminate battery.

### BACKGROUND

As disclosed in Patent Literature 1, laminate batteries (pouch batteries), and specifically, batteries comprising, for example, an electrode laminate, current collector terminals electrically connected to the electrode laminate, and a laminate film which covers the electrode laminate and a part of the current collector terminals to seal the electrode laminate are known.

### CITATION LIST

### Patent Literature

[PTL 1] Japanese Unexamined Patent Publication (Kokai) No. 2015-103291

### SUMMARY

### Technical Problem

Batteries may be exposed to salt water due to car accidents and natural disasters. In connection thereto, the present inventors have discovered that certain metals constituting the positive electrode current collector terminal may be electrochemically corroded due to short circuiting via salt water, and as a result, the positive electrode current collector terminal becomes completely corrode before the battery is fully discharged, whereby salt water can enter the laminate film, causing contact between the salt water and the charged electrode laminate.

The present disclosure aims to provide a laminate battery having a reduced risk of the positive electrode current collector terminal corroding completely before the battery is fully discharged, and with which contact between salt water and charged electrode laminate can be suppressed.

### Solution to Problem

The present inventors have discovered that the above problem can be solved by the following means.

### Aspect 1

A laminate battery, comprising:
an electrode laminate,
a negative electrode current collector terminal electrically connected to a negative electrode current collector of the electrode laminate,
a positive electrode current collector terminal electrically connected to a positive electrode current collector of the electrode laminate, and
a laminate film for sealing the electrode laminate, wherein
the positive electrode current collector terminal is formed of a metal which can be electrolytically corroded by a discharge potential of the electrode laminate, and
(i) a volume of the positive electrode current collector terminal is greater than a volume which can be electrolytically corroded by a capacitance of the electrode laminate, and/or
(ii) the positive electrode current collector terminal has a structure in which, in positions which are sealed by the laminate film, a cross-sectional area increases toward an end not electrically connected to the positive electrode current collector.

### Aspect 2

The laminate battery according to Aspect 1, wherein the (i) is satisfied.

### Aspect 3

The laminate battery according to Aspect 1, wherein the (ii) is satisfied.

### Aspect 4

The laminate battery according to Aspect 3, wherein the structure is a stepped structure or a tapered structure.

### Aspect 5

The laminate battery according to any one of Aspects 1 to 4, which is a sulfide-based solid-state battery.

### Advantageous Effects of Invention

According to the present disclosure, a laminate battery having a reduced risk of the positive electrode current collector terminal corroding before the battery is fully discharged, and with which contact between salt water and the charged electrode laminate can be suppressed can be provided.

### BRIEF DESCRIPTION OF DRAWINGS

FIG. 1 is a schematic plan view showing an example of a laminate battery of the present disclosure.

FIG. 2 is a schematic side view showing an example of the laminate battery of the present disclosure, in which the vicinity of the positive electrode current collector terminal is enlarged.

FIG. 3A is a schematic side view showing an example of the laminate battery of the present disclosure, in which the vicinity of the positive electrode current collector terminal is enlarged.

FIG. 3B is a schematic side view showing an example of the laminate battery of the present disclosure, in which the vicinity of the positive electrode current collector terminal is enlarged.

FIG. 4 is a schematic side view showing an example of a conventional laminate battery, in which the vicinity of the positive electrode current collector terminal is enlarged.

FIG. 5 is a graph showing the relationship between battery capacity and the aluminum volume required to consume the battery capacity.

### DESCRIPTION OF EMBODIMENTS

The embodiments of the present disclosure will be described in detail below. It is note that the present disclosure is not limited to the following embodiments, and various modifications can be implemented within the scope of the spirit of the disclosure.

### <<Laminate Battery>>

The laminate battery (pouch battery) of the present disclosure comprises an electrode laminate, a negative electrode current collector terminal electrically connected to a negative electrode current collector of the electrode laminate, a positive electrode current collector terminal electrically connected to a positive electrode current collector of the electrode laminate, and a laminate film for sealing the electrode laminate. The positive electrode current collector terminal is formed of a metal which can be electrolytically corroded by a discharge potential of the electrode laminate, and (i) a volume of the positive electrode current collector terminal is greater than a volume which can be electrolytically corroded by a capacitance of the electrode laminate, and/or (ii) the positive electrode current collector terminal has a structure in which, in positions which are sealed by the laminate film, a cross-sectional area increases toward an end not electrically connected to the positive electrode current collector.

When a battery is exposed to salt water due to a car accident or a natural disaster such as a tsunami, in the positive electrode current collector terminal and negative electrode current collector terminal of the battery, a short circuit via salt water can cause the following reactions (if the positive electrode current collector terminal is composed of aluminum (Al)):

(Positive electrode) Al→Al³⁺+3e⁻,2H₂O→4H⁺+4e⁻+O₂(↑) (a)

(Negative electrode) 2H₂O+2e⁻→2OH⁻+H₂(↑). (b)

Specifically, in the negative electrode current collector terminal of the battery, as indicated by formula (b) above, only hydrogen gas is generated, whereas in the positive electrode current collector terminal of the battery, as indicated by formula (a) above, the metal such as aluminum (Al) constituting the current collector terminals may be electrochemically corroded (electrolytic corrosion). Thus, as shown in FIG. 4, in a positive electrode current collector terminal that does not have the necessary volume to consume the battery capacity, the positive electrode current collector terminal is completely corroded before the battery is fully discharged, whereby salt water can enter the laminate film from the position where the positive electrode current collector terminal was located, causing contact between the salt water and the charged electrode laminate.

In this regard, the present inventors have discovered that the above problem can be solved by increasing the volume of the positive electrode current collector terminal.

Furthermore, as shown in FIG. 4, when the thickness of the positive electrode current collector terminal is insufficient, oxygen gas generated due to corrosion will accumulate near the positive electrode current collector terminal, whereby the corrosion reaction of the positive electrode current collector terminal, specifically, discharge may stop, and thus the battery capacity may remain.

Regarding this, the present inventors have discovered that the above problem can be suppressed by devising the shape of the positive electrode current collector terminal. Specifically, and without intending to be bound by theory, by giving the positive electrode current collector terminal a structure in which, in positions which are sealed by the laminate film, the cross-sectional area increases toward the end not electrically connected to the positive electrode current collector, it is believed that it is possible to suppress the oxygen gas generated due to corrosion from accumulating near the positive electrode current collector terminal, whereby it is possible to efficiently reduce the battery capacity without stopping discharge.

The laminate battery of the present disclosure may be a liquid-based battery or a solid-state battery. It is note that in the context of the present disclosure, “solid-state battery” means a battery in which at least a solid electrolyte is used as the electrolyte, and thus, the solid-state battery may use a combination of a solid electrolyte and a liquid electrolyte as the electrolyte. Furthermore, the solid-state battery of the present disclosure may be an all-solid-state battery, and specifically, a battery in which only a solid electrolyte is used as the electrolyte.

The battery of the present disclosure may be a lithium-ion secondary battery. Examples of applications of the battery include the power source for vehicles such as hybrid vehicles (HEV), plug-in hybrid vehicles (PHEV), electric vehicles (BEV), gasoline vehicles, and diesel vehicles. In particular, it is preferably used as the power source for driving a hybrid vehicle (HEV), plug-in hybrid vehicle (PHEV), or electric vehicle (BEV). Furthermore, the battery of the present disclosure may be used as the power source for a moving body other than a vehicle (for example, a train, ship, or aircraft), or as the power source for an electrical product such as an information processing device.

The laminate battery of the present disclosure will be described below with reference to the drawings. It is note that the dimensional relationships in each drawing do not reflect the actual dimensional relationships.

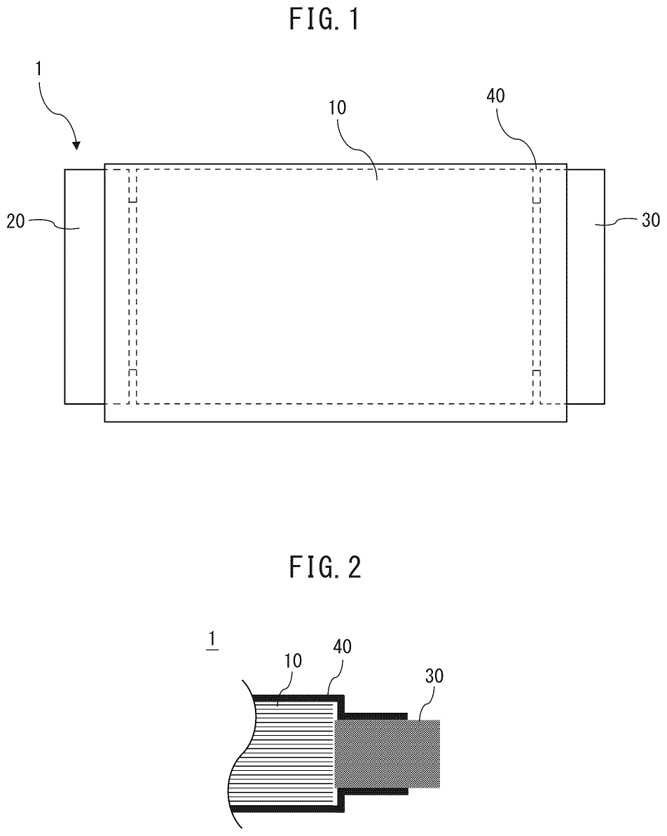

As shown in FIG. 1, the laminate battery 1 of the present disclosure comprises an electrode laminate 10, a negative electrode current collector terminal 20 electrically connected to the negative electrode current collector of the electrode laminate 10, a positive electrode current collector terminal 30 electrically connected to the positive electrode current collector of the electrode laminate 10, and a laminate film 40 for sealing the electrode laminate 10.

### <Electrode Laminate>

The electrode laminate 10 functions as a power generation element of the battery 1.

The electrode laminate 10 comprises a negative electrode current collector and a positive electrode current collector. The electrode laminate 10 may comprise a negative electrode current collector, a negative electrode active material layer, an electrolyte layer, a positive electrode active material layer, and a positive electrode current collector in this order.

Though the shape of the electrode laminate 10 is not particularly limited, it may have, for example, a top surface, a bottom surface opposite to the top surface, and four side surfaces connecting the top surface and the bottom surface. The shape of the top surface is not particularly limited, and examples thereof include quadrilaterals such as square, rectangle, rhombus, trapezoid, and parallelogram. Furthermore, the shape of the top surface may be a polygon other than a quadrilateral, or may be a shape having a curve such as a circle. Furthermore, the shape of the bottom surface is similar to the shape of the top surface. The shapes of the side surfaces are not particularly limited, and examples thereof include quadrilaterals such as square, rectangle, rhombus, trapezoid, and parallelogram.

### <Negative Electrode Current Collector Terminal>

The negative electrode current collector terminal 20 is electrically connected to the negative electrode current collector of the electrode laminate 10.

The material of the negative electrode current collector terminal 20 is not particularly limited as long as it has a current collecting function, and for example, the same metal material as the negative electrode current collector can be adopted.

The size, shape, etc., of the negative electrode current collector terminal 20 are not particularly limited.

### <Positive Electrode Current Collector Terminal>

The positive electrode current collector terminal 30 is electrically connected to the positive electrode current collector of the electrode laminate 10.

The positive electrode current collector terminal 30 is formed of a metal which can be electrolytically corroded by the discharge potential of the electrode laminate 10. Aluminum is an example of a metal which can be electrolytically corroded by the discharge potential of the electrode laminate 10, but the metal is not limited thereto.

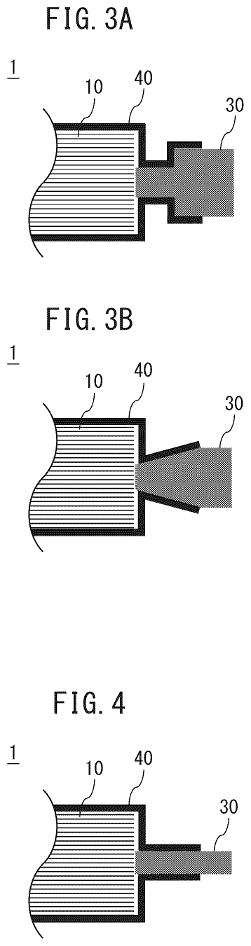

As shown in FIG. 2, in the laminate battery 1 of the present disclosure, (i) the volume of the positive electrode current collector terminal 30 is greater than the volume which can be electrolytically corroded by a capacitance of the electrode laminate 10, and/or as shown in FIG. 3, (ii) the positive electrode current collector terminal 30 has a structure in which, in positions which are sealed by the laminate film 40, a cross-sectional area increases toward an end not electrically connected to the positive electrode current collector.

In an embodiment, the laminate battery 1 of the present disclosure satisfies (i) above. By adopting this configuration, it is considered that contact between salt water and the charged electrode laminate 10 due to the positive electrode current collector terminal 30 completely corroding before battery 1 is fully discharged and salt water entering the laminate film from the position where the positive electrode current collector terminal 30 was located can be made less likely to occur.

The volume of the positive electrode current collector terminal 30, which is greater than the volume which can be electrolytically corroded by the capacitance of the electrode laminate 10, specifically, the volume of the positive electrode current collector terminal 30 required to completely consume the battery capacity, can be calculated as follows. First, the number of Coulombs (unit: C) is calculated from the current value (unit: A) and the discharge time (unit: s) during discharge of the battery 1. The required amount of electrons (unit: mol) is calculated from the calculated number of Coulombs and Faraday's constant (unit: C/mol). For example, when the material constituting the positive electrode current collector terminal 30 is Al, the required amount of electrons is converted to a required amount of Al (unit: mol) based on the oxidation reaction formula of Al. The required volume of Al (unit: cm³) can be calculated by converting the required amount of Al based on the atomic weight of Al (unit: g) and the density of Al (unit: g/cm³).

For reference, Table 1 shows the volume of Al required for a predetermined battery capacity calculated by the above method.

TABLE 1

| Battery capacity (Ah) | 1 | 50 | 100 | 500 |
|---|---|---|---|---|
| Number of Coulombs (C) | 3600 | 180000 | 360000 | 1800000 |
| Required amount of | 0.04 | 1.87 | 3.73 | 18.66 |
| electrons (mol) | | | | |
| Required amount of Al | 0.01 | 0.62 | 1.24 | 6.22 |
| (mol) | | | | |
| Required weight of Al | 0.34 | 16.79 | 33.58 | 167.9 |
| (g) | | | | |
| Required volume of Al | 0.1 | 6 | 12 | 62 |
| (cm³) | | | | |

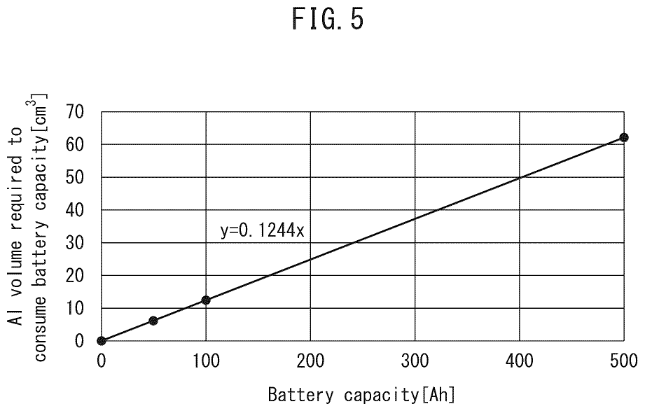

A graph showing the relationship between the battery capacity and the required volume of Al of the table above is shown in FIG. 5. According to the linear approximation formula of this graph, the relationship between the battery capacity and the required volume of Al is expressed by the following formula (1):

$$y = 0.1244 x \qquad ( 1 )$$

where y is the required volume of Al, and x is the battery capacity.

In an embodiment, the laminate battery 1 of the present disclosure satisfies (ii) above. By adopting this configuration, oxygen gas generated due to corrosion of the positive electrode current collector terminal 30 can be prevented from accumulating near the positive electrode current collector terminal 30, and thus, it is considered that the capacity of the battery can be efficiently reduced without stopping discharge.

In an embodiment that satisfies (ii) above, the structure of the positive electrode current collector terminal 30 may be a stepped structure (refer to FIG. 3A) or a tapered structure (refer to FIG. 3B).

### <Laminate Film>

The laminate film 40 seals the electrode laminate 10. The laminate film 40 may seal the electrode laminate 10 together with the negative electrode current collector terminal 20 and the positive electrode current collector terminal 30. Specifically, the laminate film 40 may seal the electrode laminate 10 along with the negative electrode current collector terminal 20 and the positive electrode current collector terminal 30 by winding around the electrode laminate 10, the negative electrode current collector terminal 20, and the positive electrode current collector terminal 30. Furthermore, the laminate film 40 may be composed of a first film and a second film, and in this case, the first film and the second film may seal the electrode laminate 10 along with the negative electrode current collector terminal 20 and the positive electrode current collector terminal 30 by sandwiching the electrode laminate 10, the negative electrode current collector terminal 20, and the positive electrode current collector terminal 30 from above and below in the lamination direction of the electrode laminate 10.

The laminate film 40 may have a fusion resin layer, a metal layer, and a protective resin layer in this order along the thickness direction. Examples of the material of the fusion resin layer include olefin resins such as polypropylene (PP) and polyethylene (PE). Examples of the material of the metal layer include aluminum, aluminum alloys, and stainless steel. Examples of the material of the protective resin layer include polyethylene terephthalate (PET) and nylon.

The laminate battery of the present disclosure may be a sulfide-based solid-state battery. When the battery is a sulfide-based solid-state battery, in the case in which salt water and the electrode laminate come into contact, a liquid containing sulfide ions dissolved therein may be generated, making post-treatment difficult. According to the laminate battery of the present disclosure, since contact between salt water and electrode laminate can be suppressed, it is possible to make it unlikely for the liquid containing sulfide ions dissolved therein to be generated.

### DESCRIPTION OF REFERENCE SIGNS

1 battery
10 electrode laminate
20 negative electrode current collector terminal
30 positive electrode current collector terminal
40 laminate film

1. A laminate battery, comprising:
an electrode laminate,
a negative electrode current collector terminal electrically connected to a negative electrode current collector of the electrode laminate,
a positive electrode current collector terminal electrically connected to a positive electrode current collector of the electrode laminate, and
a laminate film for sealing the electrode laminate, wherein
the positive electrode current collector terminal is formed of a metal which can be electrolytically corroded by a discharge potential of the electrode laminate, and
(i) a volume of the positive electrode current collector terminal is greater than a volume which can be electrolytically corroded by a capacitance of the electrode laminate, and/or
(ii) the positive electrode current collector terminal has a structure in which, in positions which are sealed by the laminate film, a cross-sectional area increases toward an end not electrically connected to the positive electrode current collector.

2. The laminate battery according to claim 1, wherein the (i) is satisfied.

3. The laminate battery according to claim 1, wherein the (ii) is satisfied.

4. The laminate battery according to claim 3, wherein the structure is a stepped structure or a tapered structure.

5. The laminate battery according to claim 1, which is a sulfide-based solid-state battery.
